(19) United States
(12) Patent Application Publication
(10) Pub. No.: US 2025/0027551 A1
(43) Pub. Date: Jan. 23, 2025

(54) MOTOR VEHICLE MOUNT, MOTOR VEHICLE AND MOUNTING ARRANGEMENT

(71) Applicant: Vibracoustic SE, Weinheim (DE)

(72) Inventors: David Rose, Hamburg (DE); Rainer Schmidt-Sunnus, Lübeck (DE); Jakob Frieß, Stelle (DE)

(21) Appl. No.: 18/775,538

(22) Filed: Jul. 17, 2024

(30) Foreign Application Priority Data
Jul. 18, 2023 (DE) 10 2023 118 899.2

(51) Int. Cl. F16F 1/393

(52) U.S. Cl. CPC F16F 1/3935

(57) ABSTRACT

A motor vehicle mount includes a mount receptacle and a central longitudinal axis. The mount receptacle has a receiving eye with a first conical inner surface portion, and a plastics collar outer sleeve. The plastics collar outer sleeve may include a collar that bears, in the installed state, around the receiving eye, a core, and an elastomer body arranged between the plastics collar outer sleeve and the core. The plastics collar outer sleeve may have an outer contour substantially complementary to the first conical inner surface portion. The first conical inner surface portion may taper, from a side facing away from the collar, toward the collar. The first conical inner surface portion may form a conical undercut, and the plastics collar outer sleeve may be secured against sliding out as to the central longitudinal axis in a first direction by the collar, and in a second direction by the undercut.

### CROSS-REFERENCE TO RELATED APPLICATIONS

This application claims priority to German Patent Application No. DE 10 2023 118 899.2, filed on Jul. 18, 2023, the contents of which is hereby incorporated by reference in its entirety.

### TECHNICAL FIELD

The invention relates to a motor vehicle mount, to a motor vehicle having at least one motor vehicle mount, and to a mounting arrangement.

### BACKGROUND

Motor vehicle mounts, motor vehicles and mounting arrangements of the kind mentioned in the introduction are generally known. Use is made of corresponding motor vehicle mounts in many places in a motor vehicle, in particular for vibration-damping mounting of components and assemblies on one another or on a body. One example is a drive engine, which has to be mounted on the body of the motor vehicle. In this case, it is necessary to prevent vibrations from being transmitted from the drive engine to the body via the motor vehicle mount, since this would lead to noticeable and audible vibrations that would impair the driving comfort. Corresponding motor vehicle mounts often have corresponding fastenings for attaching the two components to be fastened together, between which a vibration-damping structure, for example a rubber damper, is introduced.

It is known practice for such motor vehicle mounts to be assigned to mount receptacles, which have a substantially cylindrical receiving eye, for attaching to a component. A sleeve, for example made of a plastic or a metal, is pressed into this receiving eye. The mount also has a core, which is attached to the other component. For this purpose, the core has, for example, a through-opening, along a central longitudinal axis, through which a fastener, for example a screw, for attaching to the other component is guided. In the case of such mounts, an elastomer body is arranged between the core and sleeve and is attached in an integrally bonded manner to the core and the sleeve by way of vulcanization and thus couples these two components together.

If an outer sleeve made of plastic is pressed into the receiving eye, relaxation of the plastic leads to a decrease in the preload, which is facilitated in particular by fluctuating and high temperatures. Since the interference fit of the sleeve in the receiving eye can be dependent on the preload, inter alia, a decrease in the preload of the sleeve in the receiving eye leads to an increased risk of the cylindrical sleeve being able to migrate axially out of the receiving eye. This risk can be prevented in one direction by a collar on the sleeve, which forms an axial form fit; by contrast, in the opposite direction, a form fit by way of a collar is not possible because of the need for axial installation. The press-out force of such a collar outer sleeve in the direction counter to the pressing direction from the receiving eye of a housing can, as a result, be too small. In particular, axial migration can occur, which can lead to defects on the motor vehicle.

If the receiving eye is part of a structure that has been produced by casting, for example aluminum die casting, then process-related draft angles are found on the inner side of the receiving eye. If a cylindrical sleeve is pressed into a receiving eye with draft angles, the tendency of the component to migrate axially is even increased. If the sleeve then also consists of a plastic and the preload force reduces over time, the risk of axial migration increases even further.

In known solutions, the draft angles on the inner side of the receiving eyes are therefore removed by machining. This is achieved, for example, by milling or finish-honing. Other solutions, in which the inner side of the receiving eyes are simultaneously provided with a saw-tooth geometry during finish-honing, are commercially known. In this case, the teeth are positioned in such a manner that it is possible for the mount to be pressed in; by contrast, in the event of the mount being pressed out, the teeth dig into the plastic, thereby leading to a considerable increase in the press-out forces. These solutions are effective, in particular in the case of mounts with collar sleeves, since the mounts cannot be pressed beyond the collar in one direction and dig into the saw teeth in the other direction. The disadvantage of such solutions is, by contrast, the additional outlay due to the finish-honing and/or the production of the saw teeth, which renders the functional unit of the mount on the corresponding receiving eye expensive.

### SUMMARY

An object of the disclosure is to increase the press-out force of a mount with a plastics outer tube without the receiving eye being machined with draft angles.

Such an objective may be achieved by a motor vehicle mount such as disclosed herein, including in various disclosed configurations.

A motor vehicle mount is described, having a mount receptacle and a central longitudinal axis, wherein the mount receptacle has a receiving eye, which has an inner surface with at least one first conical inner surface portion, and a plastics collar outer sleeve, which is held in the mount receptacle, wherein the plastics collar outer sleeve has a radially oriented collar, wherein the collar bears, in the installed state on the mount receptacle, around the receiving eye, a core, which extends substantially axially, and an elastomer body, which is arranged between the plastics collar outer sleeve and the core, wherein the plastics collar outer sleeve has an outer contour that is substantially complementary to the at least one first conical inner surface portion of the receiving eye, wherein the first conical inner surface portion tapers, from a side facing away from the collar, toward the collar, wherein the first conical inner surface portion that corresponds to the outer contour of the plastics collar outer sleeve forms a conical undercut, with the result that the plastics collar outer sleeve is secured against sliding out with respect to the central longitudinal axis in a first direction by the collar, and in a second direction opposite the first direction by the conical undercut.

A motor vehicle mount can be used for various purposes, for example as a link mount, a pendulum support mount, a subframe mount, an auxiliary frame mount, a transmission transverse bridge mount, a differential mount, a housing for mounting motor vehicle assemblies such as a battery box mount or a transmission mount.

The mount receptacle can be designed as a separate component or as an integrated component, for example in a housing for an assembly or for a drive component of a motor vehicle.

The receiving eye can have a substantially or completely rotationally symmetrical design. In this case, it can be provided that the axial direction is oriented, in the installed state, substantially in the direction of gravity or substantially horizontally.

A plastics collar outer sleeve, elastomer body, and core may form a mounting arrangement.

A plastics collar outer sleeve, which can comprise or consist, for example, of a plastics or fiber-reinforced plastics material suitable for injection molding, is inserted into the receiving eye. A large number of thermoplastics, thermosets and elastomers are suitable for injection molding. Especially for the injection molding of technical plastics parts, tried-and-tested engineering plastics, such as PA6, PBT, PES, POM, PSU or in particular PA66 are available. These plastics can be fiber-reinforced in order to increase the stiffness and in order to decrease the tendency to relax.

The plastics collar outer sleeve has an elastomer body, which is arranged radially on the inside and is non-adhesively or adhesively connected to, for example vulcanized onto, the plastics collar outer sleeve. The elastomer body can consist of natural rubber or a synthetic elastomer such as EPDM. The elastomer body is responsible for the majority of the vibration-damping function of the motor vehicle mount.

The elastomer body has a core, in particular a cylindrical core, which lies radially on the inside and has an axial through-opening, which is used to attach one of the two components to be attached together. The cylindrical core can consist of plastic or metal, for example aluminum. The core can be adhesively attached to, in particular vulcanized into, the elastomer body. The through-opening can also have a cylindrical configuration and can receive, for example, a screw, a bolt or a threaded bolt.

The plastics collar outer sleeve, elastomer body and core can have a substantially coaxial and substantially rotationally symmetrical construction.

The first conical inner surface portion forms a frustoconical lateral surface, on which the plastics collar outer sleeve bears with at least partial surface-area contact.

The collar of the plastics collar outer sleeve secures the plastics collar outer sleeve against axial migration in a first direction. In an opposite second direction, a form-fitting connection is produced by the conical undercut, as a result of which migration in a second direction opposite the first direction can be prevented. This succeeds in increasing the press-out force in the second direction to such an extent that unintended pressing out during operation can be ruled out.

According to a first further aspect, it can be provided that the inner surface of the receiving eye has at least one second conical inner surface portion, wherein the first conical inner surface portion and second conical inner surface portion taper or widen toward the inside of the receiving eye, wherein the outer contour of the plastics collar outer sleeve is substantially complementary to the inner surface of the receiving eye.

The corresponding biconical configuration, in which two frustoconical lateral surfaces transition into one other, allows the receiving eye to be demolded particularly easily.

According to another further aspect, it can be provided that the mount receptacle consists of metal, in particular of cast metal, in particular of die-cast aluminum.

Such a mount receptacle can be an integral constituent part of a component or of the body of the motor vehicle or be a separate element, which can be rigidly attached, for example, to the body or to the component.

According to another further aspect, it can be provided that the inner surface of the receiving eye is unmachined. Firstly, this reduces the production outlay of the mount receptacle.

According to another further aspect, it can be provided that the at least one first conical inner surface portion of the receiving eye is a demolding contour.

This makes it easier to construct the mount receptacle and makes it possible to use inexpensive casting methods without complex subsequent mechanical machining of the inner contour.

According to another further aspect, it can be provided that the plastics collar outer sleeve has an increasing radial extent in the first direction at least partially in the region facing away from the collar and corresponding to the first conical inner surface portion.

This allows the motor vehicle mount to be optimized for applications in which there is a high load in the axial direction of the motor vehicle mount and the mount has a strong axial progression.

In the case of a configuration of this kind, it can be provided that the elastomer body has a decreasing radial extent.

According to another further aspect, it can be provided that an uninstalled plastics collar outer sleeve has a larger contour diameter than a diameter of the inner surface of the receiving eye at the same axial height, with the result that, in the installed state, the plastics collar outer sleeve is compressed.

This allows a press fit to be created, which enables a more secure fit of the plastics collar outer sleeve.

According to a further aspect, the plastics collar outer sleeve can have an axially running compression slot that, when compressed, generates pressure in the elastomer strip and as a result can bring about a more favorable stress state in the elastomer body, which can lead to an increased service life. Once the slot is closed, further pressure can be induced in the elastomer when the mount is being pressed into the receiving eye on account of the press fit.

According to another further aspect, it can be provided that the plastics collar outer sleeve has a rib structure on an outer lateral surface.

This allows the maximum material thickness of the plastics collar outer sleeve to be reduced, for example to a value of less than or equal to 5 mm. The reduced material thicknesses due to the rib structure considerably speed up the injection molding process and render the production more cost-effective.

According to another further aspect, it can be provided that the plastics collar outer sleeve has at least one annular clearance on its outer lateral surface.

According to another further aspect, it can be provided that the annular clearance corresponds to the smallest inner diameter of the receiving eye with respect to its axial position.

According to another further aspect, it can be provided that the outer contour, which corresponds to the first conical inner surface portion, of the sleeve body encloses an obtuse angle with the collar in a longitudinal section.

This allows the undercut to be created in a particularly simple manner.

A first independent subject relates to a motor vehicle having at least one motor vehicle mount of the aforementioned kind.

Another independent subject relates to a mounting arrangement for a motor vehicle mount of the aforementioned kind.

The motor vehicle mount has a mount receptacle with a receiving eye, which has an inner surface with at least one first conical inner surface portion, wherein the mounting arrangement is designed to be received in the mounting arrangement.

The mounting arrangement has a plastics collar outer sleeve, wherein the plastics collar outer sleeve has a radially oriented collar, wherein the collar bears, in the installed state on the mount receptacle, around the receiving eye, a core, which extends substantially axially, and an elastomer body, which is arranged between the plastics collar outer sleeve and the core, wherein the plastics collar outer sleeve has an outer contour that is substantially complementary to the at least one first conical inner surface portion of the receiving eye, wherein the first conical inner surface portion tapers, from a side facing away from the collar, toward the collar, wherein the first conical inner surface portion that corresponds to the outer contour of the plastics collar outer sleeve forms a conical undercut, with the result that the plastics collar outer sleeve and thus the motor vehicle mount are secured against sliding out with respect to the central longitudinal axis in a first direction by the collar, and in a second direction opposite the first direction by the conical undercut.

### BRIEF DESCRIPTION OF THE DRAWINGS

Further features, details and advantages of the invention are apparent from the wording of the claims and from the following description of exemplary embodiments on the basis of the drawings, in which:

FIG. 1 shows a sectional illustration through a motor vehicle mount in a first embodiment;

FIG. 2 shows a sectional illustration through a motor vehicle mount in a second embodiment;

FIG. 3 shows a sectional illustration through a motor vehicle mount in a third embodiment;

FIG. 4 shows a side view of the motor vehicle mount from FIG. 3, and

FIG. 5 shows a perspective view of the motor vehicle mount from FIG. 3.

### DETAILED DESCRIPTION

In the exemplary embodiments described below, components that are the same or have the same effect are provided with the same reference signs for better readability.

The invention is not restricted to any of the above-described embodiments but may be modified in a very wide variety of ways.

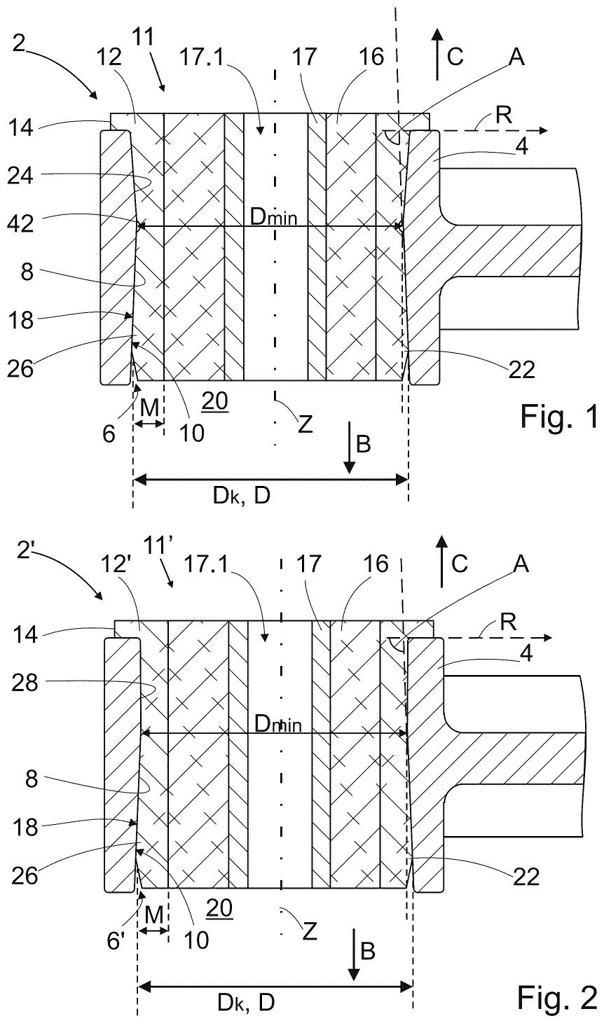

FIG. 1 shows a sectional illustration through a motor vehicle mount 2.

The motor vehicle mount 2 has a mount receptacle 4, which has a receiving eye 6 with an inner surface 8, which defines a first conical inner surface portion 10. The first conical inner surface portion 10 corresponds substantially to a frustoconical lateral surface.

Arranged in the receiving eye 6 is a mounting arrangement 11 with a plastics collar outer sleeve 12, which has a collar 14 that protrudes substantially radially and bears against the mount receptacle 4. The plastics collar outer sleeve 12 fits in the mount receptacle 4 in a form-fitting manner. The collar 14 of the plastics collar outer sleeve 12 prevents the plastics collar outer sleeve 12 from migrating out of the receiving eye 6 in a first direction B. In the present exemplary embodiment, the plastics collar outer sleeve 12 consists of fiber-reinforced PA 66. Alternative embodiments can use other plastics with or without fiber reinforcement.

The plastics collar outer sleeve 12 has a coaxial cylindrical cavity, in which an elastomer body 16 is adhesively arranged. In the present case, the elastomer body 16 consists of a natural-rubber-based rubber compound.

The elastomer body 16 has a coaxial cylindrical cavity, in which a cylindrical core 17 with a through-hole 17.1 is arranged so as to adhere to the elastomer body 16. In the present case, the core 17 consists of a metal, wherein, for example, aluminum or steel are suitable. A screw, a bolt or a threaded bolt can be inserted into the through-hole 17.1, in order to fasten the mount thereto.

The plastics collar outer sleeve 12, elastomer body 16, and cylindrical core 17 are designed to be substantially rotationally symmetrical with respect to a central longitudinal axis Z.

The plastics collar outer sleeve 12 has an outer contour 18, which substantially corresponds to a contour of the inner surface 8.

A conical undercut 22 is produced on a side 20 of the motor vehicle mount 2 facing away from the collar by the first conical inner surface portion 10, said conical undercut resulting in the plastics collar outer sleeve 12 not being able to migrate in a second direction C oriented opposite the first direction B during operation. A press-out force needed is considerably increased by the conical undercut 22. In conjunction with the collar 14, the plastics collar outer sleeve 12 can thus be secured in both directions B, C.

In the present exemplary embodiment, the mount receptacle 4 furthermore has a second conical inner surface portion 24, which transitions into the first conical inner surface portion 10, in the receiving eye 6. This arrangement forms a double-frustoconical-lateral-surface structure, which produces an inner diameter with the smallest width Dmin at the transition between the first conical inner surface portion 10 and second conical inner surface portion 24. An inner surface diameter D varies along the central longitudinal axis Z, but is always larger than or equal to the inner diameter with the smallest width Dmin.

In a region 26 of the plastics collar outer sleeve 12 facing away from the collar, a radial extent M of the plastics collar outer sleeve 12 increases.

The plastics collar outer sleeve 12 can be slightly overdimensioned with respect to the inner surface 8 of the receiving eye 6 in order to achieve higher clamping on account of the resulting press fit, wherein a contour diameter Dk of the plastics collar outer sleeve 12 in the uninstalled state is larger at least in certain sections at a corresponding axial height than the inner surface diameter D of the receiving eye 6.

An angle A between a radial direction R and the first conical inner surface portion 10 is obtuse, thereby producing the conical undercut 22.

Additionally, an annular clearance 42 is arranged at the point at which the two cones of the outer contour 18 meet. This is favorable for matching the tolerances of the double cones to the inner geometry of the receiving eye 6.

FIG. 2 shows a sectional illustration through a motor vehicle mount 2′ with a mounting arrangement 11′ in a second possible exemplary embodiment.

In contrast to the first exemplary embodiment according to FIG. 1, a cylindrical inner surface portion 28 is provided instead of a second conical inner surface portion. As a result, a biconical inner surface 8′ is not produced, which simplifies matching the tolerance sequences at the mount 2′ and receiving eye 6′ to one another.

In all other respects, reference is made to the descriptions regarding the first exemplary embodiment.

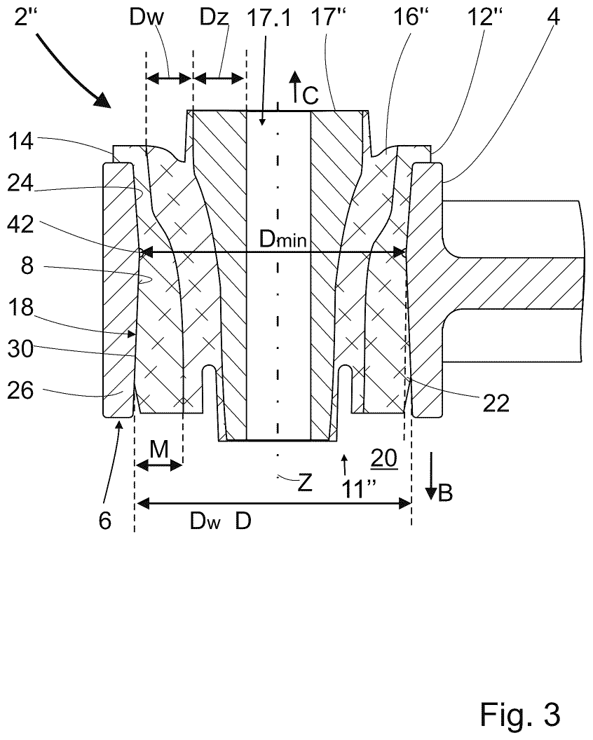

FIG. 3 shows a sectional illustration through a motor vehicle mount 2″ with a mounting arrangement 11″ in a third possible exemplary embodiment.

In the present exemplary embodiment, the shapes of the plastics collar outer sleeve 12″ and elastomer body 16″ are more complex than in the first two exemplary embodiments. The radial extent M of the plastics collar outer sleeve 12″ increases in the first direction B and an outer diameter of the elastomer body 16″ correspondingly decreases. The elastomer body 16″ has a wedge-like shape and has a substantially constant wall thickness Dw over the length, whereas a wall thickness Dz of the core 17″ decreases in the first direction B. As a result of the wedge shape of the elastomer body 16″, such a mount 2″ has an increasingly progressive stiffness profile in the event of a load in direction B, with the result that this mount is able to absorb large forces in this direction.

As in the first exemplary embodiment according to FIG. 1, a lateral surface 30 of the plastics collar outer sleeve 12″ runs in the form of a double cone, in each case from the end sides toward the center of the lateral surface 30, for which reason, in all other respects, reference is made to the corresponding descriptions from FIG. 1.

Additionally, an annular clearance 42 is arranged at the point at which the two cones of the outer contour 18″′ meet. This is favorable for matching the tolerances of the double cones to the inner geometry of the receiving eye 6.

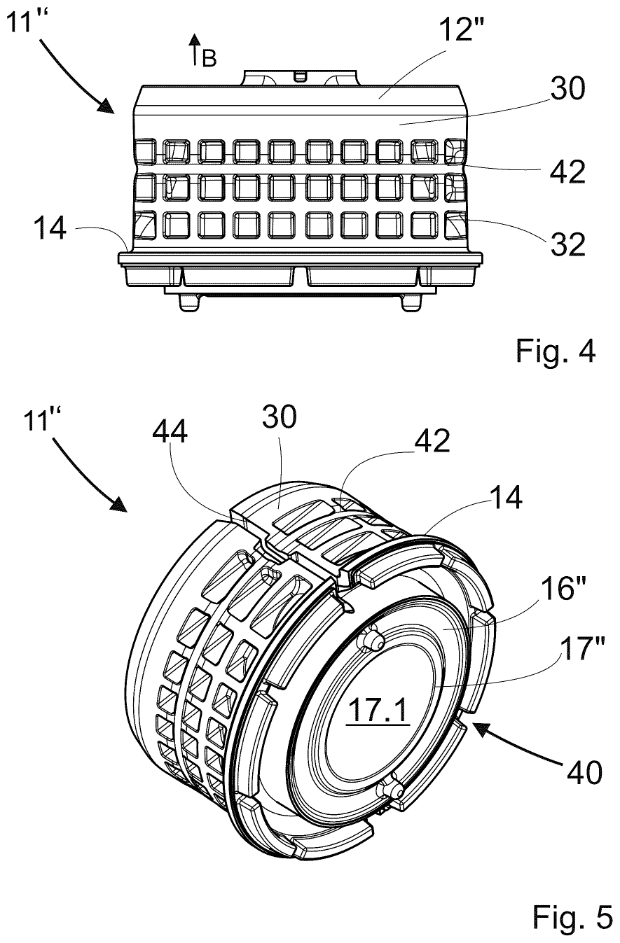

FIG. 4 shows a side view of the mounting arrangement 11″ from FIG. 3 without the mount receptacle 4.

Arranged on the lateral surface 30 is a rib structure 32, which causes a maximum material thickness of the plastics collar outer sleeve 12 to remain below a value that is critical for production, in this case approximately 4 mm, despite the large radial extent M (see FIG. 3) of the plastics collar sleeve 12″. As a result, production is considerably simplified and sped up, with virtually the same compression stiffness as in the case of a solid structure, which is important for the press fit.

FIG. 5 shows a perspective view of the mounting arrangement 11″.

An axial compression slot 44, which enables a considerable compression of the elastomer body 16″ beyond the proportion from the press fit, is arranged on the lateral surface 30.

In all other respects, reference is made to the descriptions regarding the first exemplary embodiment.

All of the features and advantages apparent from the claims, the description and the drawing, including structural details, spatial arrangements and process steps, may be essential to the invention both individually and in a very wide variety of combinations.

1. A motor vehicle mount, comprising:
a mount receptacle; and
a central longitudinal axis,
wherein the mount receptacle has a receiving eye having an inner surface with at least one first conical inner surface portion, and a plastics collar outer sleeve held in the mount receptacle;
wherein the plastics collar outer sleeve has a radially oriented collar;
wherein the collar bears, in an installed state on the mount receptacle, around the receiving eye, a core, which extends substantially axially, and an elastomer body, which is arranged between the plastics collar outer sleeve and the core;
wherein the plastics collar outer sleeve has an outer contour that is substantially complementary to the at least one first conical inner surface portion of the receiving eye;
wherein the first conical inner surface portion tapers, from a side facing away from the collar, toward the collar; and
wherein the first conical inner surface portion that corresponds to the outer contour of the plastics collar outer sleeve forms a conical undercut, and the plastics collar outer sleeve is secured against sliding out with respect to the central longitudinal axis in a first direction by the collar, and in a second direction opposite the first direction by the conical undercut.

2. The motor vehicle mount as recited in claim 1, wherein the inner surface of the receiving eye has at least one second conical inner surface portion, wherein the first conical inner surface portion and second conical inner surface portion taper or widen toward an inside of the receiving eye, and wherein the outer contour of the plastics collar outer sleeve is substantially complementary to the inner surface of the receiving eye.

3. The motor vehicle mount as recited in claim 1, wherein the mount receptacle comprises metal.

4. The motor vehicle mount as recited in claim 1, wherein the mount receptacle comprises cast metal.

5. The motor vehicle mount as recited in claim 1, wherein the mount receptacle comprises die cast aluminium.

6. The motor vehicle mount as recited in claim 1, wherein the inner surface of the receiving eye is unmachined.

7. The motor vehicle mount as recited in claim 1, wherein the at least one first conical inner surface portion of the receiving eye is a demolding contour.

8. The motor vehicle mount as recited in claim 1, wherein the plastics collar outer sleeve has an increasing radial extent in the first direction at least partially in a region facing away from the collar and corresponding to the first conical inner surface portion.

9. The motor vehicle mount as recited in claim 1, wherein an uninstalled plastics collar outer sleeve has a larger contour diameter than a diameter of the inner surface of the receiving eye at the same axial height, such that, in the installed state of the plastics collar outer sleeve, the plastics collar outer sleeve is compressed.

10. The motor vehicle mount as recited in claim 1, wherein the plastics collar outer sleeve has a rib structure on an outer lateral surface.

11. The motor vehicle mount as recited in claim 1, wherein the plastics collar outer sleeve has at least one annular clearance on its outer lateral surface.

12. The motor vehicle mount as recited in claim 11, wherein the annular clearance corresponds to the smallest inner diameter of the receiving eye with respect to its axial position.

13. The motor vehicle mount as recited in claim 1, wherein the plastics collar outer sleeve has at least one axial compression slot.

14. The motor vehicle mount as recited in claim 1, wherein the outer contour, which corresponds to the first conical inner surface portion, of the sleeve body encloses an obtuse angle with the collar in a longitudinal section.

15. A motor vehicle having at least one motor vehicle mount as claimed in claim 1.

16. A mounting arrangement for a motor vehicle mount as claimed in claim 1.
